(19) United States
(12) Patent Application Publication
(10) Pub. No.: US 2002/0120689 A1
(43) Pub. Date: Aug. 29, 2002

(54) Method of enabling usage of multilingual characters in internet e-mail addresses

(75) Inventors: Maynard J-Lon Kang, Singapore (SG); Ching Hong Seng, Johor (MY)

Correspondence Address: BEYER WEAVER & THOMAS LLP, P.O. BOX 778, BERKELEY, CA, 94704-0778, US

(73) Assignee: i-DNS.net International Pte. Ltd.

(21) Appl. No.: 09/792,293

(22) Filed: Feb. 23, 2001

(51) Int. Cl. G06F 15/16

(52) U.S. Cl. 709/206; 709/235

(57) ABSTRACT

A method, implemented on an apparatus, of transporting an electronic mail message which designates an addressee by a multilingual e-mail address (MLEA). The MLEA is associated with an encoding type. The method includes receiving the MLEA; detecting the encoding type of the MLEA; converting the MLEA to a corresponding ASCII compatible encoding e-mail address (ACEEA) in accordance with the encoding type of the MLEA; and sending the e-mail message with the corresponding ACEEA. The conversion from the MLEA to the ACEEA is performed by one of a end user personal computer, a web-based mail server, a mail server, and a LDAP server.

### BACKGROUND OF THE INVENTION

The present invention relates to Internet e-mail systems. More particularly, the invention relates to alternative or modified Internet e-mail systems which accepts e-mail addresses provided in many different encoding formats other than ASCII.

The Internet has evolved from a purely research and academic entity to a global network that reaches a diverse community with different languages and cultures. In all areas, the Internet has progressed to address the localization needs of its audience. As a result, today, electronic mail (e-mail) messages are exchanged in various languages.

However, to provide universality, Internet e-mail addresses have been represented only using the 7-bit US-ASCII character set due to legacy problems in existing mail systems. No provision is made to allow for e-mail addresses to be in a non-ASCII native language. The implication is that any user of the Internet has to have some basic knowledge of ASCII characters.

While this does not pose a problem to technical or business users who, generally speaking, are able to understand English as an international language of science, technology, business, and politics, it is a stumbling block to the rapid proliferation of the Internet to countries where English is not widely spoken. In those countries, the Internet neophyte must understand basic English as a prerequisite to send e-mail in her own native language because the e-mail address cannot support the native language even though the e-mail application can.

Moreover, users of European languages also have to approximate their e-mail addresses without accents and so on. Mr. Francois from France has to constantly bear the irritation of deliberately mis-typing his e-mail address as “francois@email.fourth” (as a fictitious example).

The above mentioned restriction in e-mail addresses is specified in many related e-mail protocol standards, such as “RFC 821-Simple Mail Transfer Protocol” (SMTP), and “RFC 822-Standard for the Format of ARPA Internet Text Messages,” which can be found at the IETF home page, http://www.ietf.org/rfc/rfc0821.txt?number=821, and http://www.ietf.org/rfc/rfc0822.txt?number=822, respectively. These standards are incorporated herein by reference in its entirety and for all purposes.

As such, Internet e-mail addresses which are represented in languages which have character repertoires outside those of the US-ASCII range (hereinafter “Multilingual E-mail Addresses,” or “MLEA”) have not been used on Internet e-mail systems. In other words, the severe restriction has limited the languages in which an Internet e-mail address can be expressed to only English, Latin, Hawaiian, Malay, etc.

In view of these and other issues, it would be highly desirable to have a technique allowing the many linguistic encoding types to be used in the Internet e-mail addresses.

### SUMMARY OF THE INVENTION

This invention provides systems and methods for internet e-mail systems which accepts e-mail addresses provided in many different encoding formats other than ASCII.

In one specific embodiment of the present invention, an international e-mail conversion software program included in an end user personal computer (PC) converts an ASCII compatible encoding e-mail address (ACEEA) to a multilingual e-mail address (MLEA). Specifically, an e-mail software program installed in the end user PC sends the MLEA to the international e-mail conversion software program. The international e-mail conversion software program receives the MLEA, detects an associated encoding type of the MLEA, converts the MLEA to the ACEEA in accordance with the encoding type of the MLEA, and sends the corresponding ACEEA to the e-mail software program. The e-mail software program sends the e-mail message by using the ACEEA instead of the MLEA.

In another specific embodiment of the present invention, the international e-mail conversion software program is included in a web-based mail server, instead of the end user PC. A sender sends an e-mail with the MLEA using HTTP to the web-based mail server via the Internet. The web-based mail server uses a web site which accepts a request for sending/receiving e-mail messages. The international e-mail conversion software program in the web-based mail server performs the conversion from the MLEA to the ACEEA. The web-based mail server sends the e-mail message with the ACEEA, saving the MLEA in a header portion of the e-mail message. Another web-based mail server receives the ACEEA included in the e-mail message, and converts the ACEEA to the MLEA. Upon request from an addressee of the e-mail message, the addressee's PC retrieves the e-mail message from the web-based mail server using HTTP.

In still another specific embodiment of the present invention, the international e-mail conversion software program is included in a mail server to perform the conversion from the MLEA to the ACEEA.

In still another specific embodiment of the present invention, the international e-mail conversion software program is included in an LDAP server to perform the conversion from the MLEA to the ACEEA.

These and other features and advantages of the present invention will be described in more detail below with reference to the drawings.

### BRIEF DESCRIPTION OF THE DRAWINGS

FIG. 1 is a schematic diagram of a network architecture for use with a specific embodiment of the method according to the present invention.

FIG. 2 is a schematic diagram of another network architecture for use with a specific embodiment of the method according to the present invention.

FIG. 3 is a schematic diagram of still another network architecture for use with a specific embodiment of the method according to the present invention.

FIG. 4 is a schematic diagram of still another network architecture for use with a specific embodiment of the method according to the present invention.

FIG. 5 is a diagram of data contained in an e-mail message created by the embodiments according to the present invention.

FIG. 6 is a block diagram illustrating a typical computer system in accordance with an embodiment of the present invention.

### DETAILED DESCRIPTION OF THE PREFERRED EMBODIMENTS

The present invention will now be described in detail with reference to the drawings, wherein like elements are referred to with like reference labels throughout.

Embodiment for Client Software

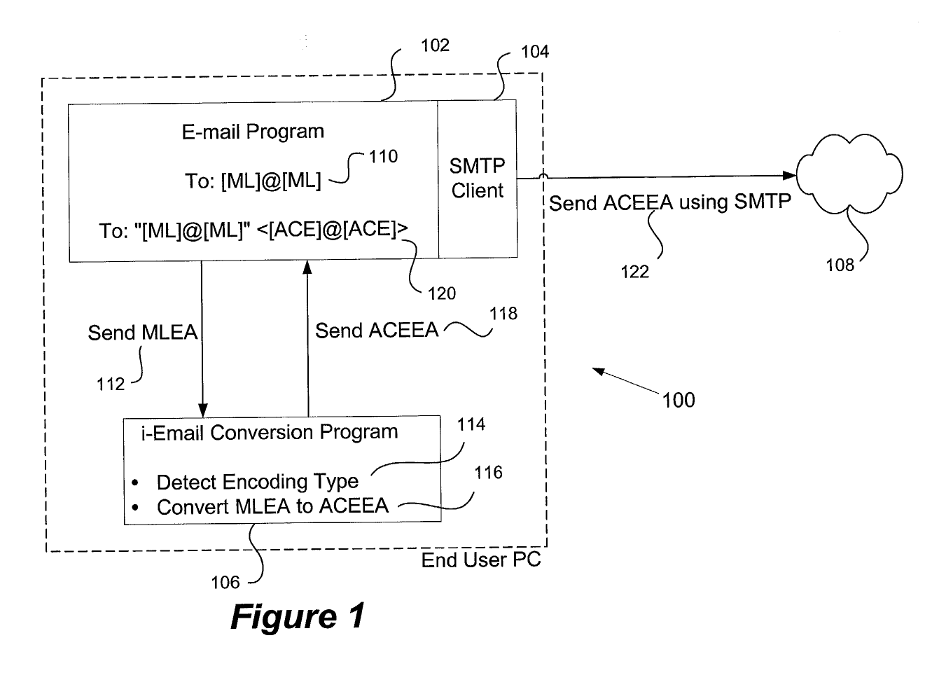

FIG. 1 is a schematic diagram of a network architecture for use with a specific embodiment of the method of enabling usage of multilingual characters in the Internet e-mail addresses according to the present invention.

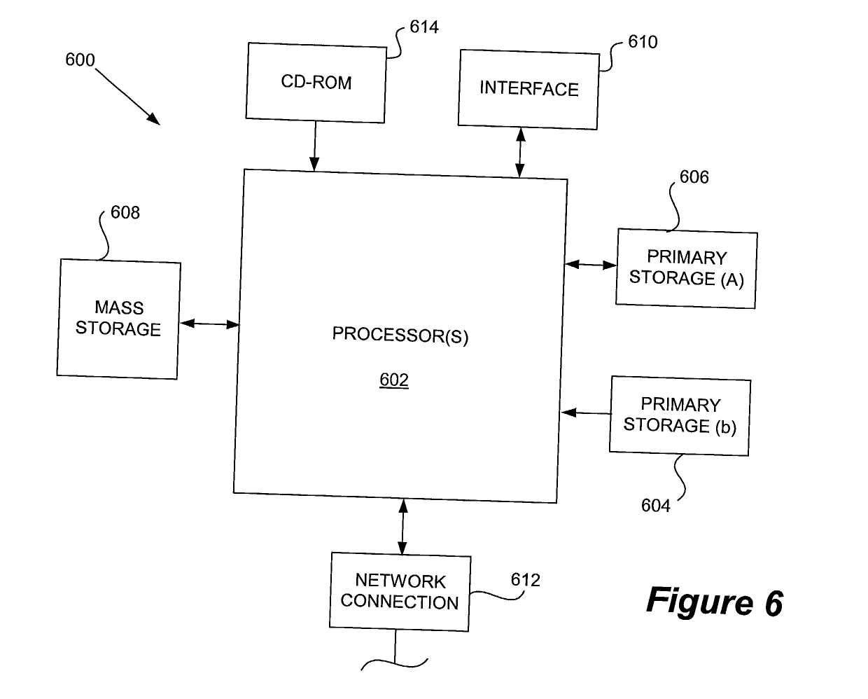

An end user PC (personal computer) 100 includes an e-mail software program 102, an SMTP (Simple Mail Transfer Protocol) client software program 104, and an international e-mail (internationalized e-mail) conversion software program 106, which are stored in a HDD (hard disk drive) of the PC 100. The end user PC 100 is operated by an end user who sends and receives Internet e-mail messages. The end user PC 100 typically has a hardware configuration described later referring to FIG. 6.

The e-mail software program 102, which is also known as a MUA (mail user agent), includes a GUI (graphical user interface) software program, and interfaces with the end user who sends and receives e-mail messages. Examples of the e-mail software program 102 include “Outlook Express” manufactured by Microsoft, “Eudora Pro” manufactured by Qualcomm, and “Messenger” manufactured by Netscape. An operation software program, such as “Windows” manufactured by Microsoft, is also installed in the end user PC 100 to accommodate the e-mail software program 102.

The SMTP client software program 104 interfaces with an SMTP server connected to the Internet 108. The SMTP client software program 104 implements the SMTP protocol as defined in the Internet RFC821 and succeeding standards documents. The end user PC 100 is connected to the Internet 108 using, for example, TCP/IP (Transmission Control Protocol/Internet Protocol).

A specific embodiment of the method and apparatus of enabling usage of multilingual e-mail addresses according to the present invention will now be described in detail referring to FIG. 1. The method and apparatus of the present invention is capable of handling both ASCII compatible encoding e-mail addresses (ACEEAs) and multilingual e-mail addresses (MLEAs). An ACEEA is an address encoded by an encoding type supported by the current Internet e-mail system (hereinafter, referred to as an “e-mail encoding type”), which is, for example, a limited set of the 7-bit US-ASCII character set. An MLEAs is an address encoded by an encoding type which is not supported by the Internet e-mail system hereinafter, referred to as a “non-e-mail encoding type”). Examples of encoding types of MLEA include GB2312, BIG5, Shift-JIS, EUC-JP, KSC5601, extended ASCII, and others.

First, the end user runs the e-mail software program 102 on the end user PC 100. At 110, the end user inputs an e-mail message address which designates an addressee by an MLEA through the GUI included in the e-mail software program 102. An MLEA is associated with a specific encoding type, for example, BIG5. In other words, each MLEA is encoded with its corresponding encoding type into a digitally represented digital sequence. The e-mail program 102 displays the inputted MLEA in a “TO:” window on a display device (e.g., a cathode ray tube display) connected to the end user PC 100. The character string “[ML]@[ML]” shown in FIG. 1 represents an e-mail address designated by a non-e-mail encoding type.

At 112, the e-mail software program 102 sends the MLEA to the international e-mail conversion software program 106, and the international e-mail conversion software program 106 receives the MLEA encoded with the corresponding encoding type. At 114, the international e-mail conversion program 106 detects the specific encoding type corresponding to the MLEA by any suitable method. In one embodiment, the program detects the encoding type by examining a mail message header that specifies an encoding type. Note that some email messages, such as those complying with RFC 822, contain a field for the encoding type. Such field is related to a “content type” field and is identified by “charset=xxx.” See RFC 2047 for a discussion of the use of this field. In another embodiment, the encoding type may be identified by matching the character/bit string of the email address against values in a table, list, tree or other appropriate data structure. Suitable examples of such methods are described in U.S. patent application Ser. No. 09/258,690 filed Feb. 26, 1999 in the name of Ching Hong Seng et al. and titled “MULTI-LANGUAGE DOMAIN NAME SERVICE;” and U.S. patent application Ser. No. ______ filed Feb. 23, 2001, in the name of Ching Hong Seng et al. and titled “MULTI-LANGUAGE DOMAIN NAME SERVICE” (Attorney Docket No. IDNSP002) which are incorporated herein by reference in its entirety and for all purposes. In a particularly preferred embodiment, the conversion program first attempts to identify the encoding type by examining the message header. If this fails, the program then uses a matching technique of the type mentioned.

At 116, the international e-mail conversion software program 106 converts the MLEA to the corresponding ACEEA by a suitable method such as that described in the above-identified U.S. patent applications Ser. Nos. 09/258,690, and ______ in the name of Ching Hong Seng et al., titled “MULTI-LANGUAGE DOMAIN NAME SERVICE.” Specifically, the international e-mail conversion software program 106 first converts the MLEA into a universal encoding type. In a preferred embodiment, this universal encoding type is Unicode, which endorses at least three forms defined in ISO/IEC 10646 transformation formats, namely, UTF-7, UTF-8, and UTF-16.

In this case, the international e-mail conversion software program 106 converts the MLEA identified in a native character set other than Unicode character sets, for example, BIG5, into the corresponding MLEA identified in one of the universal encoding types using Unicode in accordance with the encoding type of the MLEA. For this conversion to the universal encoding type, the encoding type of the MLEA is necessary since an identical code value may be assigned to two different characters in different character sets. In other words, a native character in a specific encoding type can be uniquely encoded in a universal encoding type by both a code value for the character and the encoding type. Then, the international e-mail conversion software program 106 converts the MLEA identified in a Unicode character set to the ACEEA. Thus, this final encoding type may be the reduced set of ASCII specified in RFC 1035.

Note that the conversion from the MLEA to the ACEEA takes place in two operations through an intermediate universal encoding type (e.g., Unicode). However, it is understood that this two-operation procedure may be modified to directly convert, in a single operation, the MLEA to the ACEEA. This may be accomplished in a system having multiple conversion algorithms, each designed to convert a specific encoding type to ASCII (or some other future e-mail compatible encoding types). In one example, these algorithms may be modeled after the “Düerst algorithm.” See, M. Düerst, “Internationalization of Domain Names,” Internet Draft “draft-duerst-dns-i18n-02.txt,” which can be found at the IETF home page, http://www.ietf.cnri.reston.va.us/ID.html, July 1998. This document is incorporated herein by reference in its entirety and for all purposes. Many other suitable algorithms are known or can be developed with routine effort.

At 118, the international e-mail conversion software program 106 sends the ACEEA back to the e-mail software program 102. At 120, the e-mail software program 102 receives the ACEEA, and displays the received ACEEA with the original MLEA in the “TO:” window on the display device. The character string “[ACE]@[ACE]” shown in FIG. 1 represents an e-mail address designated by an e-mail encoding type.

At 122, when the end user completes an e-mail message and clicks a “send” icon created by the e-mail software program 102, the e-mail software program 102 sends the e-mail message to an addressee designated by the ACEEA through the SMTP client 104 in an SMTP format. The e-mail software program 102 may save the MLEA in the native character set, and the corresponding encoding type of the MLEA in, for example, a header portion of the e-mail message. The saved MLEA and its encoding type can be used for later restoration of the MLEA in the addressee's e-mail software program for displaying the MLEA. The ACEEA of the e-mail message is resolved in the similar manner described in the above-identified U.S. patent applications Nos. 09/258,690, and ______ in the name of Ching Hong Seng et al., titled “MULTI-LANGUAGE DOMAIN NAME SERVICE.”

In the specific embodiment for use with the network architecture shown in FIG. 1, the end user PC 100 originates the e-mail message to the addressee on the Internet, and converts the MLEA in the e-mail message to the corresponding ACEEA by the international e-mail conversion program 106 installed in the end user PC 100. In this embodiment, the e-mail software program 102 triggers the conversion from the MLEA to the ACEEA.

The end user PC 100 typically includes one or more processors, and at least one processor in the end user PC 100 executes the e-mail software program 102, the SMTP client 104, and the international e-mail conversion software program 106. The SMTP client 104 sends the e-mail message with the corresponding ACEEA using SMTP to the addressee designated by the ACEEA.

Embodiment for Web Server Software

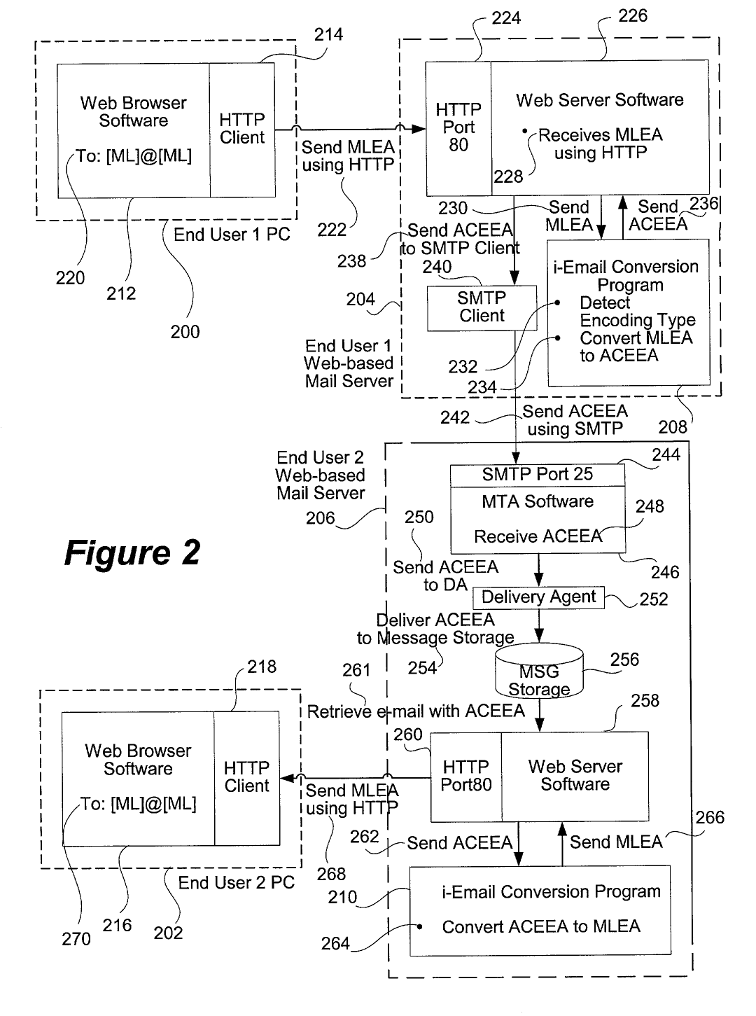

FIG. 2 is a schematic diagram of a network architecture for use with another specific embodiment of the method of enabling usage of multilingual characters in the Internet e-mail addresses according to the present invention. In the network architecture of FIG. 2, a sender uses an end user PC 200 to send an e-mail message with an MLEA to an addressee who uses an end user PC 202 through a web-based mail server 204 which is closer to the sender, and a web-based mail server 206 which is closer to the addressee. The web-based mail servers 204 and 206 provide services enabling users to send and receive e-mail messages by accessing a web site through which the users can post an e-mail message to be sent, or read a received e-mail message. Examples of such web-based e-mail services include Hotmail by Microsoft, and Yahoo! Mail by Yahoo.

In this specific embodiment of the present invention illustrated in FIG. 2, an international e-mail conversion program 208 installed in the web-based mail server 204 detects an encoding type of an MLEA, and convert the MLEA to a corresponding ACEEA. An international e-mail conversion program 210 installed in the web-based mail server 206 receives the converted ACEEA, and converts the ACEEA to the MLEA. The details of the embodiment will now be described referring to FIG. 2.

The end user PC 200 for the sender includes a web browser software program 212, and an HTTP client software program 214, which are stored in a HDD of the end user PC 200. Similarly, the end user PC 202 for the addressee includes a web browser software program 216, and an HTTP client software program 218, which are stored in a HDD of the end user PC 202. The end user PCs 200 and 202 typically have a hardware configuration described later referring to FIG. 6. Each of the web browser software programs 212 and 216 includes a GUI software program, and interfaces with the sender and the addressee through a web site which interfaces with those e-mail users. Examples of the web browser software programs 212 and 216 include “Internet Explorer” manufactured by Microsoft, and “Netscape Navigator” manufactured by Netscape. An operation software program, such as “Windows” manufactured by Microsoft, is also installed in the end user PCs 200 and 202 to accommodate the web-based browser software programs 212 and 216.

The HTTP client software programs 214 and 218 interface with web-based mail servers 204 and 206, respectively, which are connected through the Internet. The HTTP client software programs 204 and 206 implement the HTTP protocol as defined in the Internet RFC1945 and succeeding standards documents, which are incorporated herein by reference in its entirety and for all purposes. The end user PCs 200 and 202 are connected to the web-based mail servers 204 and 206, respectively, through the Internet using, for example, TCP/IP.

A specific embodiment of the method and apparatus of enabling usage of multilingual e-mail addresses according to the present invention will now be described in detail referring to FIG. 2. The method and apparatus of the present invention is capable of handling both ACEEAs and MLEAs.

First, the sender runs the web browser software program 212 on the end user PC 200 to access a web site which provides web-based e-mail services, and opens a page which provides, for example, a “TO:” window, a “CC:” window, a “BCC:” window, and a “body text for the message” window as typically used in the web-based e-mail services. At 220, the sender inputs an e-mail message address which designates an addressee by an MLEA through the GUI provided by the web-based mail server 204. An MLEA is associated with a specific encoding type, for example, BIG5. In other words, each MLEA is encoded with its corresponding encoding type into a digitally represented digital sequence. The web browser software program 212 displays the inputted MLEA in a “TO:” window on a display device (e.g., a cathode ray tube display) connected to the end user PC 200. The character string “[ML]@[ML]” shown in FIG. 2 represents an e-mail address designated by a non-e-mail encoding type. The end user PC 200 enables the sender of the e-mail message to input the MLEA by using a software program for inputting a native language character set other than the limited ASCII character set.

At 222, when the end user completes an e-mail message and clicks a “send” icon created by the web browser software program 212 in the web-based e-mail service page, the web browser software program 212 sends in an HTTP format the e-mail message of which addressee is designated by the MLEA to the web-based mail server 204 through the HTTP client 214 in the end user PC 200 and an HTTP port 224 in the web-based mail server 204. The web browser software program 212 sends the MLEA in the native character set. The HTTP port 224 is assigned as “Port 80” in the web-based mail server 204 to handle data communications using HTTP. The mail transfer with the MLEA from the end user PC 200 to the web-based mail server 204 is triggered by the sender's click on a “send the e-mail message” icon in the page for the web-based e-mail services.

At 228, a web server software program 226 receives the MLEA through the HTTP port 224 using HTTP. At 230, the web server software program 226 then sends the MLEA to the international e-mail conversion software program 208 installed in the web-based mail server 204, and the international e-mail conversion software program 208 receives the MLEA encoded with the corresponding encoding type. At 232, the international e-mail conversion program 208 detects the specific encoding type corresponding to the MLEA by identifying the encoding type as specified in a message header and/or by a method described in the above-identified U.S. patent applications Ser. Nos. 09/258,690, and ______ in the name of Ching Hong Seng et al., titled “MULTI-LANGUAGE DOMAIN NAME SERVICE.” This approach to identifying an encoding type is essentially the same as that set forth above for the Client Software embodiment.

At 234, the international e-mail conversion software program 208 converts the MLEA to the corresponding ACEEA by a method such as that described in the above-identified U.S. patent applications Ser. Nos. 09/258,690, and ______ in the name of Ching Hong Seng et al., titled “MULTI-LANGUAGE DOMAIN NAME SERVICE.” Specifically, the international e-mail conversion software program 208 first converts the MLEA into a universal encoding type. In a preferred embodiment, this universal encoding type is Unicode, which endorses at least three forms defined in ISO/IEC 10646 transformation formats, namely, UTF-7, UTF-8, and UTF-16.

In this case, the international e-mail conversion software program 208 converts the MLEA identified in a native character set other than Unicode character sets, for example, BIG5, into the corresponding MLEA identified in one of the universal encoding types using Unicode in accordance with the encoding type of the MLEA. For this conversion to the universal encoding type, the encoding type of the MLEA is necessary since an identical code value may be assigned to two different characters in different character sets. In other words, a native character in a specific encoding type can be uniquely encoded in a universal encoding type by both a code value for the character and the encoding type. Then, the international e-mail conversion software program 208 converts the MLEA identified in a Unicode character set to the ACEEA. Thus, this final encoding type may be the reduced set of 15 ASCII specified in RFC 1035.

Note that the conversion from the MLEA to the ACEEA takes place in two operations through an intermediate universal encoding type (e.g., Unicode).

However, it is understood that this two-operation procedure may be modified to directly convert, in a single operation, the MLEA to the ACEEA. This may be accomplished in a system having multiple conversion algorithms, each designed to convert a specific encoding type to ASCII (or some other future e-mail compatible encoding types). In one example, these algorithms may be modeled after the above-identified “Düerst algorithm.” Many other suitable algorithms are known or can be developed with routine effort. At 236, the international e-mail conversion software program 208 sends the ACEEA back to the web server software program 226.

At 238, the web server software program 226 receives the ACEEA, and sends the e-mail message to the SMTP client 240. The web server software program 226 may save the MLEA in the native character set, and the corresponding encoding type of the MLEA in, for example, a header portion of the e-mail message. The saved MLEA and its encoding type can be used for later restoration of the MLEA in the international e-mail conversion software program 210 for displaying the MLEA in the end user PC 202. The ACEEA of the e-mail message is resolved in the similar manner described in the above-identified U.S. patent applications Ser. Nos. 09/258,690, and ______ in the name of Ching Hong Seng et al., titled “MULTI-LANGUAGE DOMAIN NAME SERVICE.”

At 242, the SMTP client 240 sends the e-mail message of which addressee is designated by the ACEEA to the web-based mail server 206 using the SMTP. At 248, an MTA (mail transfer agent) software program 246 receives the e-mail of which addressee is designated by the ACEEA through an SMTP port 244. The SMTP port 244 is assigned as “Port 25” in the web-based mail server 206 to handle data communications using SMTP. At 250, the MTA software program 246 sends the e-mail message which contains the ACEEA, the MLEA, and the associated encoding type to a delivery agent 252. At 254, the delivery agent 252 sends the e-mail message which contains the ACEEA, the MLEA, and the associated encoding type to a message storage 256. The message storage 256 stores an incoming e-mail message until a web server software program 258 requests retrieval of the e-mail message from the message storage 256.

When the addressee checks e-mail messages, the addressee of the e-mail message runs the web browser software program 216, and clicks a “receive messages” icon in the web-based e-mail services page. Then, the web browser software program 216 sends a request for retrieval of e-mail messages to the web-based mail server 206.

When the web server software program 258 receives the request for retrieval of e-mail messages from the addressee through the web browser software program 216, the HTTP client 218, and an HTTP port 260 via the Internet, at 261, the web server software program 258 retrieves the e-mail message containing the ACEEA, the MLEA, and the associated encoding type from the message storage 256.

At 262, the web server software program 258 then sends the ACEEA with the encoding type of the MLEA to the international e-mail conversion software program 210 installed in the web-based mail server 206, and the international e-mail conversion software program 210 receives the ACEEA and the associated encoding type. At 264, the international e-mail conversion software program 210 converts the ACEEA to the corresponding MLEA based on the associated encoding type included in the header portion of the e-mail message. The international e-mail conversion software program 210 performs the conversion in a single process since the corresponding MLEA is uniquely determined by utilizing both the ACEEA and the associated encoding type of the MLEA.

At 266, the international e-mail conversion software program 210 sends the restored MLEA back to the web server software program 258, and the web server software program 258 receives the MLEA. At 268, the web server software program 258 sends the e-mail message to the end user PC 202 of the addressee who requested the retrieval of e-mail messages through the Internet using HTTP. The web browser software program 216 receives the e-mail message through the HTTP client 218 via the Internet.

Then, finally, the web browser software program 216 displays the MLEA in the “TO:” window for the e-mail message using the native character set. As a result, the addressee can see the MLEA on the display screen of the end user PC 202.

In the specific embodiment for use with the network architecture shown in FIG. 2, the e-mail message is transported through an originating server, namely the web-based mail server 204, and a destination server, namely the web-based mail server 206, in this order. The conversion from the MLEA to the ACEEA is performed in the originating server. In this embodiment, the web server software program 226 provided in the originating server (i.e., the web-based mail server 204) triggers the conversion from the MLEA to the ACEEA. The conversion from the ACEEA to the MLEA is performed in the destination server.

The web-based mail server 204 typically includes one or more processors, and at least one processor in the web-based mail server 204 executes the web server software program 226, the SMTP client 240, and the international e-mail conversion software program 208. Similarly, the web-based mail server 206 typically includes one or more processors, and at least one processor in the web-based mail server 206 executes the web server software program 258, the MTA software program 246, and the international e-mail conversion software program 210.

Embodiment for Mail Server Software

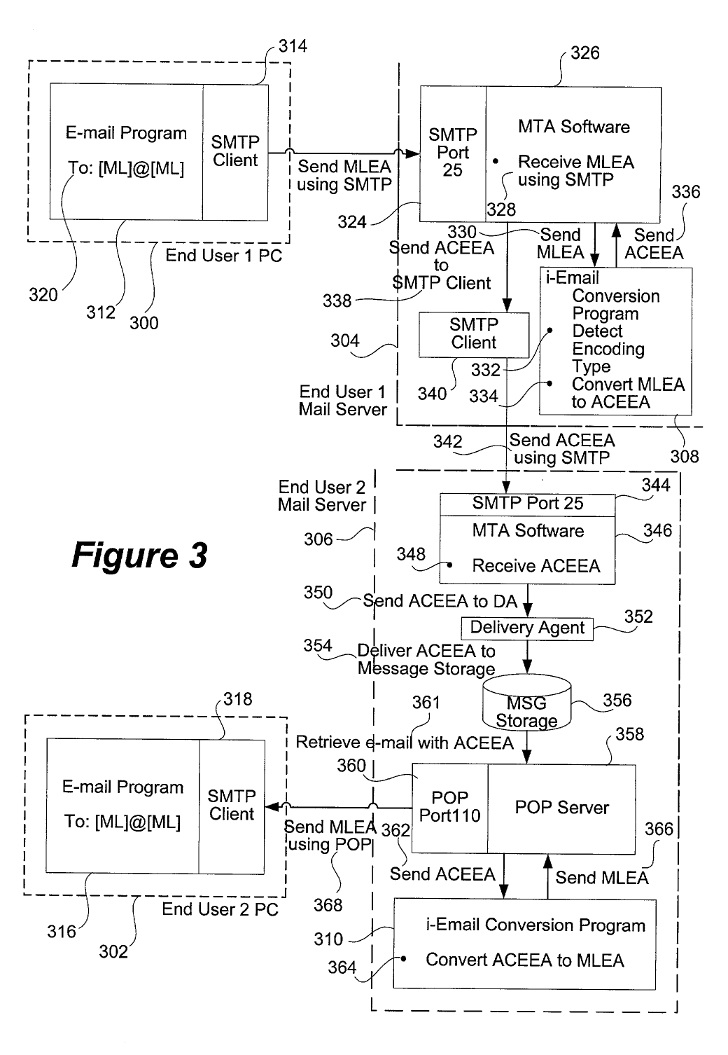

FIG. 3 is a schematic diagram of a network architecture for use with another specific embodiment of the method of enabling usage of multilingual characters in the Internet e-mail addresses according to the present invention. In this embodiment, an e-mail message is transferred from a send to an addressee through two mail servers which perform conversions between an MLEA and an ACEEA, instead of the two web-based mail servers described referring to FIG. 2.

In the network architecture of FIG. 3, the sender uses an end user PC 300 to send an e-mail message with an MLEA to the addressee who uses an end user PC 302 through a mail server 304 which is closer to the sender, and a mail server 306 which is closer to the addressee. The mail servers 304 and 306 provide services enabling users to send and receive e-mail messages by using an e-mail software program. Examples of such an e-mail software program include “Outlook Express” manufactured by Microsoft, “Eudora Pro” manufactured by Qualcomm, and “Messenger” manufactured by Netscape.

In this specific embodiment of the present invention illustrated in FIG. 3, an international e-mail conversion program 308 installed in the web-based mail server 304 detects an encoding type of an MLEA, and convert the MLEA to a corresponding ACEEA. An international e-mail conversion program 310 installed in the web-based mail server 306 receives the converted ACEEA, and converts the ACEEA to the MLEA. The details of the embodiment will now be described referring to FIG. 3.

The end user PC 300 for the sender includes an e-mail software program 312, and an SMTP client software program 314, which are stored in a HDD of the end user PC 300. Similarly, the end user PC 302 for the addressee includes an e-mail software program 316, and an SMTP client software program 318, which are stored in a HDD of the end user PC 302. The end user PCs 300 and 302 typically have a hardware configuration described later referring to FIG. 6. Each of the e-mail software programs 312 and 316 includes a GUI software program, and interfaces with the sender and the addressee through mail servers which interfaces with those e-mail users. Examples of the e-mail software programs 312 and 316 include “Outlook Express” manufactured by Microsoft, “Eudora Pro” manufactured by Qualcomm, and “Messenger” manufactured by Netscape. An operation software program, such as “Windows” manufactured by Microsoft, is also installed in the end user PCs 300 and 302 to accommodate the web-based browser software programs 312 and 316.

The SMTP client software programs 314 and 318 interface with web-based mail servers 304 and 306, respectively, which are connected through the Internet. The SMTP client software programs 204 and 206 implement the SMTP protocol as defined in the Internet RFC821 and succeeding standards documents. The end user PCs 300 and 302 are connected to the web-based mail servers 304 and 306, respectively, through the Internet using, for example, TCP/IP.

A specific embodiment of the method and apparatus of enabling usage of multilingual e-mail addresses according to the present invention will now be described in detail referring to FIG. 3. The method and apparatus of the present invention is capable of handling both ACEEAs and MLEAs.

First, the sender runs the e-mail software program 312 on the end user PC 300. At 320, the sender inputs an e-mail message address which designates an addressee by an MLEA through the GUI included in the e-mail software program 312. An MLEA is associated with a specific encoding type, for example, BIG5. In other words, each MLEA is encoded with its corresponding encoding type into a digitally represented digital sequence. The e-mail software program 312 displays the inputted MLEA in a “TO:” window on a display device (e.g., a cathode ray tube display) connected to the end user PC 300. The character string “[ML]@[ML]” shown in FIG. 3 represents an e-mail address designated by a non-e-mail encoding type. The end user PC 300 enables the sender of the e-mail message to input the MLEA by using a software program for inputting a native language character set other than the limited ASCII character set.

At 322, when the end user completes an e-mail message and clicks a “send” icon created by the e-mail software program 312, the e-mail software program 312 sends in an SMTP format the e-mail message of which addressee is designated by the MLEA to the mail server 304 through the SMTP client 314 in the end user PC 300 and an SMTP port 324 in the mail server 304. The e-mail software program 312 sends the MLEA in the native character set. The SMTP port 324 is assigned as “Port 25” in the mail server 304 to handle data communications using SMTP. The mail transfer with the MLEA from the end user PC 300 to the mail server 304 is triggered by the sender's click on a “send the e-mail message” icon in the e-mail software program 312.

At 328, an MTA software program 326 receives the MLEA through the SMTP port 324 using SMTP. At 330, the MTA software program 326 then sends the MLEA to the international e-mail conversion software program 308 installed in the mail server 304, and the international e-mail conversion software program 308 receives the MLEA encoded with the corresponding encoding type. At 332, the international e-mail conversion program 308 detects the specific encoding type corresponding to the MLEA by a suitable method such as examining an email message header for a field identifying the encoding type. Alternatively, or in addition, encoding type detection may be accomplished using a method of the type described in the above-identified U.S. patent applications Ser. Nos. 09/258,690, and ______ in the name of Ching Hong Seng et al., titled “MULTI-LANGUAGE DOMAIN NAME SERVICE.” Generally, the detection process may proceed as described above for the Client Software embodiment.

At 334, the international e-mail conversion software program 308 converts the MLEA to the corresponding ACEEA by a method such as that described in the above-identified U.S. patent applications Ser. Nos. 09/258,690, and ______ in the name of Ching Hong Seng et al., titled “MULTI-LANGUAGE DOMAIN NAME SERVICE.” Specifically, the international e-mail conversion software program 308 first converts the MLEA into a universal encoding type. In a preferred embodiment, this universal encoding type is Unicode, which endorses at least three forms defined in ISO/IEC 10646 transformation formats, namely, UTF-7, UTF-8, and UTF-16.

In this case, the international e-mail conversion software program 308 converts the MLEA identified in a native character set other than Unicode character sets, for example, BIG5, into the corresponding MLEA identified in one of the universal encoding types using Unicode in accordance with the encoding type of the MLEA. For this conversion to the universal encoding type, the encoding type of the MLEA is necessary since an identical code value may be assigned to two different characters in different character sets. In other words, a native character in a specific encoding type can be uniquely encoded in a universal encoding type by both a code value for the character and the encoding type. Then, the international e-mail conversion software program 308 converts the MLEA identified in a Unicode character set to the ACEEA. Thus, this final encoding type may be the reduced set of ASCII specified in RFC 1035.

Note that the conversion from the MLEA to the ACEEA takes place in two operations through an intermediate universal encoding type (e.g., Unicode). However, it is understood that this two-operation procedure may be modified to directly convert, in a single operation, the MLEA to the ACEEA. This may be accomplished in a system having multiple conversion algorithms, each designed to convert a specific encoding type to ASCII (or some other future e-mail compatible encoding types). In one example, these algorithms may be modeled after the above-identified “Düerst algorithm.” Many other suitable algorithms are known or can be developed with routine effort. At 336, the international e-mail conversion software program 308 sends the ACEEA back to the web server software program 326.

At 338, the MTA software program 326 receives the ACEEA, and sends the e-mail message to the SMTP client 340. The MTA software program 326 may save the MLEA in the native character set, and the corresponding encoding type of the MLEA in, for example, a header portion of the e-mail message. The saved MLEA and its encoding type can be used for later restoration of the MLEA in the international e-mail conversion software program 310 for displaying the MLEA in the end user PC 302. The ACEEA of the e-mail message may be resolved in the similar manner described in the above-identified U.S. patent applications Ser. Nos. 09/258,690, and ______ in the name of Ching Hong Seng et al., titled “MULTI-LANGUAGE DOMAIN NAME SERVICE.”

At 342, the SMTP client 340 sends the e-mail message of which addressee is designated by the ACEEA to the mail server 306 using the SMTP. At 348, an MTA software program 346 receives the e-mail of which addressee is designated by the ACEEA through an SMTP port 344. The SMTP port 344 is assigned as “Port 25” in the mail server 306 to handle data communications using SMTP. At 350, the MTA software program 346 sends the e-mail message which contains the ACEEA, the MLEA, and the associated encoding type to a delivery agent 352. At 354, the delivery agent 352 sends the e-mail message which contains the ACEEA, the MLEA, and the associated encoding type to a message storage 356. The message storage 356 stores an incoming e-mail message until a POP (Post Office Protocol) server software program 358 requests retrieval of the e-mail message from the message storage 356. The POP server software program 358 uses POP3 (Post Office Protocol Ver. 3) defined in RFC1225, which is incorporated herein by reference in its entirety and for all purposes.

When the addressee checks e-mail messages, the addressee of the e-mail message runs the e-mail software program 316, and clicks a “receive messages” icon in the e-mail software program 316. Then, the e-mail software program 316 sends a request for retrieval of e-mail messages to the mail server 306.

When the POP server software program 358 receives the request for retrieval of e-mail messages from the addressee through the e-mail software program 316, the SMTP client 318, and a POP port 360 via the Internet, at 361, the POP server software program 358 retrieves the e-mail message containing the ACEEA, the MLEA, and the associated encoding type from the message storage 356.

At 362, the POP server software program 358 then sends the ACEEA with the encoding type of the MLEA to the international e-mail conversion software program 310 installed in the mail server 306, and the international e-mail conversion software program 310 receives the ACEEA and the associated encoding type. At 364, the international e-mail conversion software program 310 converts the ACEEA to the corresponding MLEA based on the associated encoding type included in the header portion of the e-mail message. The international e-mail conversion software program 310 performs the conversion in a single process since the corresponding MLEA is uniquely determined by utilizing both the ACEEA and the associated encoding type of the MLEA.

At 366, the international e-mail conversion software program 310 sends the restored MLEA back to the web server software program 358, and the web server software program 358 receives the MLEA. At 368, the web server software program 358 sends the e-mail message to the end user PC 302 of the addressee who requested the retrieval of e-mail messages through the Internet using POP3. The e-mail software program 316 receives the e-mail message through the SMTP client 318 via the Internet.

Then, finally, the web browser software program 316 displays the MLEA in the “TO:” window for the e-mail message using the native character set. As a result, the addressee can see the MLEA on the display screen of the end user PC 302.

In the specific embodiment for use with the network architecture shown in FIG. 3, the e-mail message is transported through an originating server, namely the mail server 304, and a destination server, namely the mail server 306, in this order. The conversion from the MLEA to the ACEEA is performed in the originating server. In this embodiment, the web server software program 326 provided in the originating server (i.e., the mail server 304) triggers the conversion from the MLEA to the ACEEA. The conversion from the ACEEA to the MLEA is performed in the destination server.

The mail server 304 typically includes one or more processors, and at least one processor in the mail server 304 executes the web server software program 326, the SMTP client 340, and the international e-mail conversion software program 308. Similarly, the mail server 306 typically includes one or more processors, and at least one processor in the web-based mail server 306 executes the POP server software program 358, the MTA software program 346, and the international e-mail conversion software program 310.

Embodiment for Directory Server Software

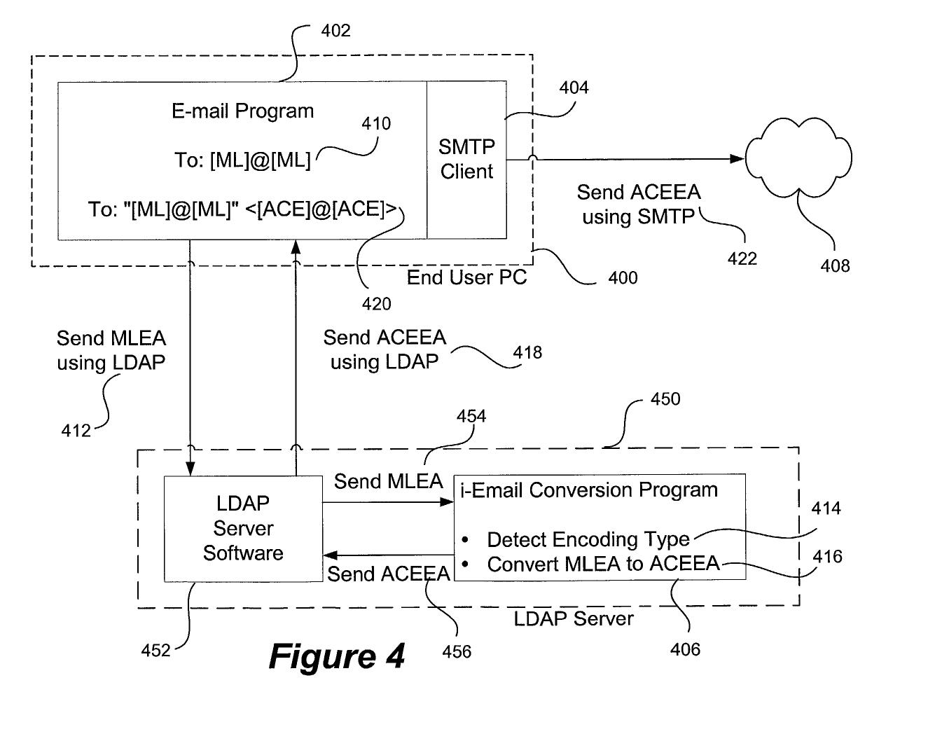

FIG. 4 is a schematic diagram of a still another network architecture for use with a specific embodiment of the method of enabling usage of multilingual characters in the Internet e-mail addresses according to the present invention.

An end user PC 400 includes an e-mail software program 402, and an SMTP client software program 404, which are stored in a HDD of the end user PC 400. A directory server, shown as an LDAP (Lightweight Directory Access Protocol) server 450, includes directory server software program (shown as an LDAP server software program 452), and an international e-mail conversion software program 406, which are stored in a HDD of the LDAP server 450. The LDAP server 450 uses the LDAP defined in RFC2251, which is incorporated herein by reference in its entirety and for all purposes. The end user PC 400 is operated by an end user who sends and receives Internet e-mail messages. The end user PC 400 typically has a hardware configuration described later referring to FIG. 6.

The e-mail software program 402, known as a MUA, includes a GUI software program, and interfaces with the end user who sends and receives e-mail messages. Examples of the e-mail software program 402 include “Outlook Express” manufactured by Microsoft, “Eudora Pro” manufactured by Qualcomm, and “Messenger” manufactured by Netscape. An operation software program, such as “Windows” manufactured by Microsoft, is also installed in the end user PC 400 to accommodate the e-mail software program 402.

The SMTP client software program 404 interfaces with an SMTP server connected to the Internet 408. The SMTP client software program 404 implements the SMTP protocol as defined in the Internet RFC821 and succeeding standards documents. The end user PC 400 is connected to the Internet 408 using, for example, TCP/IP.

A specific embodiment of the method and apparatus of enabling usage of multilingual e-mail addresses according to the present invention will now be described in detail referring to FIG. 4. The method and apparatus of the present invention is capable of handling both ACEEAs and MLEAs.

First, the end user runs the e-mail software program 402 on the end user PC 400. At 410, the end user inputs an e-mail message address which designates an addressee by an MLEA through the GUI included in the e-mail software program 402. An MLEA is associated with a specific encoding type, for example, BIG5. In other words, each MLEA is encoded with its corresponding encoding type into a digitally represented digital sequence. The e-mail program 402 displays the inputted MLEA in a “TO:” window on a display device (e.g., a cathode ray tube display) connected to the end user PC 400. The character string “[ML]@[ML]” shown in FIG. 1 represents an e-mail address designated by a non-e-mail encoding type.

At 412, the e-mail software program 402 sends the MLEA to the LDAP server software program 452 installed in the LDAP server 450, and the LDAP server software program 452 receives the MLEA encoded with the corresponding encoding type. Then, at 454, the LDAP server software program 452 sends the MLEA to the international e-mail conversion program 406 installed in the LDAP server 450 using LDAP.

At 414, the international e-mail conversion program 406 detects the specific encoding type corresponding to the MLEA by a method suitable method such as those described above in the Client Software embodiment. For this purpose, suitable matching techniques are described in the above-identified U.S. patent applications Ser.Nos. 09/258,690 and ______ in the name of Ching Hong Seng et al., titled “MULTI-LANGUAGE DOMAIN NAME SERVICE.”

At 416, the international e-mail conversion software program 406 converts the MLEA to the corresponding ACEEA by a method such as that described in the above-identified U.S. patent applications Ser. No. 09/258,690, and ______ in the name of Ching Hong Seng et al., titled “MULTI-LANGUAGE DOMAIN NAME SERVICE.” Specifically, the international e-mail conversion software program 406 first converts the MLEA into a universal encoding type. In a preferred embodiment, this universal encoding type is Unicode, which endorses at least three forms defined in ISO/IEC 10646 transformation formats, namely, UTF-7, UTF-8, and UTF-16.

In this case, the international e-mail conversion software program 406 converts the MLEA identified in a native character set other than Unicode character sets, for example, BIG5, into the corresponding MLEA identified in one of the universal encoding types using Unicode in accordance with the encoding type of the MLEA. For this conversion to the universal encoding type, the encoding type of the MLEA is necessary since an identical code value may be assigned to two different characters in different character sets. In other words, a native character in a specific encoding type can be uniquely encoded in a universal encoding type by both a code value for the character and the encoding type. Then, the international e-mail conversion software program 106 converts the MLEA identified in a Unicode character set to the ACEEA. Thus, this final encoding type may be the reduced set of ASCII specified in RFC 1035.

Note that the conversion from the MLEA to the ACEEA takes place in two operations through an intermediate universal encoding type (e.g., Unicode). However, it is understood that this two-operation procedure may be modified to directly convert, in a single operation, the MLEA to the ACEEA. This may be accomplished in a system having multiple conversion algorithms, each designed to convert a specific encoding type to ASCII (or some other future e-mail compatible encoding types). In one example, these algorithms may be modeled after the above-identified “Düerst algorithm.” Many other suitable algorithms are known or can be developed with routine effort.

At 456, the international e-mail conversion software program 406 sends the ACEEA back to the LDAP server software program 452. At 418, the LDAP server software program 452 sends the ACEEA to the e-mail software program 402 using LDAP. At 420, the e-mail software program 402 receives the ACEEA, and displays the received ACEEA with the original MLEA in the “TO:” window on the display device. The character string “[ACE]@[ACE]” shown in FIG. 4 represents an e-mail address designated by an e-mail encoding type.

At 422, when the end user completes an e-mail message and clicks a “send” icon created by the e-mail software program 402, the e-mail software program 402 sends the e-mail message to an addressee designated by the ACEEA through the SMTP client 404 in an SMTP format. The e-mail software program 402 may save the MLEA in the native character set, and the corresponding encoding type of the MLEA in, for example, a header portion of the e-mail message. The saved MLEA and its encoding type can be used for later restoration of the MLEA in the addressee's e-mail software program for displaying the MLEA. The ACEEA of the e-mail message may be resolved in the similar manner described in the above-identified U.S. patent applications Ser. Nos. 09/258,690, and ______ in the name of Ching Hong Seng et al., titled “MULTI-LANGUAGE DOMAIN NAME SERVICE.”

In the specific embodiment for use with the network architecture shown in FIG. 4, the end user PC 400 originates the e-mail message to the addressee on the Internet, and the LDAP server 450 converts the MLEA in the e-mail message to the corresponding ACEEA by the international e-mail conversion program 406 installed in the LDAP server 450. In this embodiment, the LDAP server software program 452 triggers the conversion from the MLEA to the ACEEA upon receiving the MLEA from the e-mail software program 402.

The end user PC 400 typically includes one or more processors, and at least one processor in the end user PC 400 executes the e-mail software program 402, and the SMTP client 404. The LDAP server 450 typically includes one or more processors, and at least one processor in the LDAP server 450 executes the LDAP server software program 452, and the international e-mail conversion software program 406. The SMTP client 404 sends the e-mail message with the corresponding ACEEA using SMTP to the addressee designated by the ACEEA.

It should be understood that although this embodiment described above referring to FIG. 4 uses an LDAP server for the conversion from the MLEA to the ACEEA, other kinds of servers may be utilized to practice the present invention. For example, servers functioning as directory servers may be utilized for the purpose of the specific embodiment of the present invention.

In this embodiment, the end user PC 400 originates the e-mail message, and the conversion from the MLEA to the ACEEA is performed in the LDAP server 450 provided outside of the end user PC 400. The e-mail software program 402 provided in the end user PC 400 triggers the converting.

Note that sometimes LDAP as implemented requires that communications with the LDAP server be made in a UTF-8 format. If this is the case, E-mail program 402 must first detect the encoding type and convert the address to UTF-8 format. Thus, the international email conversion program need not detect the encoding type. It merely needs to convert the UTF-8 string to the ACEEA.

The conversion from the MLEA to the ACEEA, and the conversion from the ACEEA to the MLEA described above referring to FIGS. 1-4 for use with the specific embodiments of the present invention can be realized by, for example, (i) traversing a tree structure containing encoding types for various MLEAs, (ii) looking up a matching table containing encoding types for various MLEAs, and (iii) retrieving the encoding type of the MLEA from a header portion of an e-mail message. The examples (i) and (ii) are disclosed in the above-identified U.S. patent applications Ser. Nos. 09/258,690, and ______ in the name of Ching Hong Seng et al., titled “MULTI-LANGUAGE DOMAIN NAME SERVICE.” The example (iii) has been fully described herein referring to FIGS. 1-4.

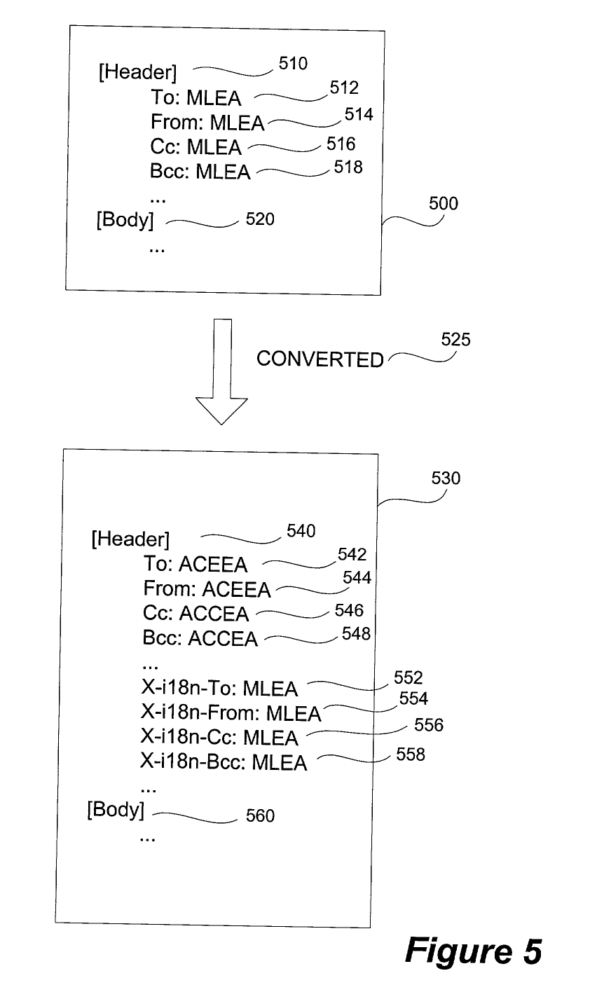

FIG. 5 is a diagram of data contained in an e-mail message created by the embodiments described above referring to FIGS. 1-4 of the method of enabling usage of multilingual characters in the Internet e-mail addresses according to the present invention. An original e-mail message data structure 500 before conversion 525 from the MLEA to the ACEEA has a header portion 510, and a body portion 520. The header portion 510 contains an MLEA in a “TO:” section 512, and an MLEA in a “FROM:” section 514. Optionally, the header portion 510 contains an MLEA in a “CC:” section 516, and an MLEA in a “BCC:” section 518.

After the conversion 525 performed by any of the international e-mail conversion software programs 106, 208, 308, and 406, a converted e-mail message data structure 530 after conversion 525 from the MLEA to the ACEEA has a header portion 540, and a body portion 560. The header portion 540 contains an ACEEA in a “TO:” section 542, and an ACEEA in a “FROM:” section 544. Optionally, the header portion 540 contains an ACEEA in a “CC:” section 546, and an ACEEA in a “BCC:” section 548. The ACEEA in the “TO:” section 542, the ACEEA in the “FROM:” section 544, the ACEEA in the “CC:” section 546, and the ACEEA in the “BCC:” section 548 are converted from the MLEA in the “TO:” section 512, the MLEA in the “FROM:” section 514, the MLEA in the “CC:” section 516, and the MLEA in the “BCC:” section 518, respectively.

The header portion 540 saves the MLEA kept in the “TO:” section 512 in a “X-i18n-TO:” section 552; the MLEA kept in the “FROM:” section 514 in a “X-i18n-FROM:” section 554; the MLEA kept in the “CC:” section 516 in a “X-i18n-CC:” section 556; and the MLEA kept in the “BCC:” section 518 in a “X-i18nBCC:” section 558. The “X-i18n-TO:” section 552; the “X-i18n-FROM:” section 554; the “X-i18n-CC:” section 556; and the “X-i18n-BCC:” section 558 are specifically designated by a section label starting “X-i18n-” to be ignored by a web server or a mail server, and to be transported transparently. Specifically, RFC822 specifies a format of an e-mail message. RFC822 is a broader standard than the MIME, which specifies how to encode texts into an e-mail message. RFC822 defines that the portion in a header starting with “x-” is treated as a comment and ignored by normal mail servers.

Embodiments of the present invention relate to an apparatus for performing the above-described method enabling usage of multilingual characters in the Internet e-mail addresses. This apparatus may be specially constructed (designed) for the required purposes, or it may be a general-purpose computer selectively activated or configured by a computer program stored in the computer. The processes presented herein are not inherently related to any particular computer or other apparatus. In particular, various general-purpose machines may be used with programs written in accordance with the teachings herein, or it may be more convenient to construct a more specialized apparatus to perform the required method operations. The required structure for a variety of these machines will appear from the description given above.

In addition, embodiments of the present invention further relate to computer readable media that include program instructions for performing various computer-implemented operations. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter.

FIG. 6 illustrates a typical computer system in accordance with an embodiment of the present invention. The computer system 600 includes any number of processors 602 (also referred to as central processing units, or CPUs) that are coupled to storage devices including primary storage 606 (typically a random access memory, or “RAM”), primary storage 604 (typically a read only memory, or “ROM”). As is well known in the art, primary storage 604 acts to transfer data and instructions uni-directionally to the CPU and primary storage 606 is used typically to transfer data and instructions in a bi-directional manner. Both of these primary storage devices may include any suitable type of the computer-readable media described above. A mass storage device 608 is also coupled bi-directionally to CPU 602 and provides additional data storage capacity and may include any of the computer-readable media described above. The mass storage device 608 may be used to store programs, data and the like and is typically a secondary storage medium such as a hard disk that is slower than primary storage. It will be appreciated that the information retained within the mass storage device 608, may, in appropriate cases, be incorporated in standard fashion as part of primary storage 606 as virtual memory. A specific mass storage device such as a CD-ROM 614 may also pass data uni-directionally to the CPU.

CPU 602 is also coupled to an interface 610 that includes one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 602 optionally may be coupled to a computer or telecommunications network using a network connection as shown generally at 612. With such a network connection, it is contemplated that the CPU might receive information from the network (e.g., requests to resolve domains), or might output information to the network in the course of performing the above-described method operations. The above-described devices and materials will be familiar to those of skill in the computer hardware and software arts.

The CPU 602 may take various forms. It may include one or more general purpose microprocessors that are selectively configured or reconfigured to implement the functions described herein. Or it may include one or more specially designed processors or microcontrollers that contain logic and/or circuitry for implementing the functions described herein. Any of the logical devices serving as CPU 602 may be designed as general purpose microprocessors, microcontrollers, application specific integrated circuits (ASICs), digital signal processors (DSPs), programmable logic devices (PLDs), field programmable gate arrays (FPGAs), and the like. They may execute instructions under the control of the hardware, firmware, software, reconfigurable hardware, combinations of these, etc.

The hardware elements described above may be configured (usually temporarily) to act as one or more software modules for performing the operations of this invention. For example, separate modules may be created from program instructions for detecting an encoding type, transforming that encoding type, and identifying a default name server may be stored on mass storage device 608 or 614 and executed on CPU 608 in conjunction with primary memory 606.

It will be understood that as a data communications protocol for use with the present invention, HTTP, POP3, IMAP4 (Interactive Mail Access Protocol Ver. 4) defined in RFC1064, and DMSP (Distributed Mail System Protocol) defined in RFC1056. The standard documents of these are incorporated herein by reference in its entirety and for all purposes.

Although the foregoing invention has been described in some detail for purposes of clarity of understanding, it will be apparent that certain changes and modifications may be practiced within the scope of the appended claims.

What is claimed is:

1. A method, implemented on an apparatus, of transporting an electronic mail (e-mail) message which designates an addressee by a multilingual e-mail address (MLEA), the MLEA being associated with an encoding type, the method comprising:
receiving the MLEA;
detecting the encoding type of the MLEA by at least one of (i) identifying the encoding type in a message header for the e-mail message and (ii) matching the a portion of the multilingual e-mail address to the encoding type of the MLEA;
converting the MLEA to a corresponding ASCII compatible encoding e-mail address (ACEEA) in accordance with the encoding type of the MLEA; and
sending the e-mail message with the corresponding ACEEA.

2. The method of claim 1, wherein a sender computer originates the e-mail message; and the converting is performed in the sender computer.

3. The method of claim 2, wherein an e-mail software program provided in the sender computer triggers the converting.

4. The method of claim 3, further comprising storing the MLEA in a header portion of the e-mail message.

5. The method of claim 4, wherein the sending comprises sending the e-mail message in a Simple Mail Transfer Protocol (SMTP) format.

6. The method of claim 1, wherein a sender computer originates the e-mail message; and the conversion is performed in a server provided outside of the sender computer.

7. The method of claim 6, wherein an e-mail software program provided in the sender computer triggers the converting.

8. The method of claim 7, further comprising storing the MLEA in a header portion of the e-mail message.

9. The method of claim 8, wherein the server is a directory server.

10. The method of claim 9, wherein the server runs Lightweight Directory Access Protocol.

11. The method of claim 10, wherein the sending comprises sending the e-mail message in a Simple Mail Transfer Protocol (SMTP) format.

12. The method of claim 1, wherein the e-mail message is transported through an originating server, and a destination server in this order, and the converting is performed in the originating server.

13. The method of claim 12, wherein a server software program provided in the originating server triggers the converting.

14. The method of claim 13, wherein the originating server is a web server.

15. The method of claim 14, wherein the sending comprises sending the e-mail message in a Hyper Text Transport Protocol (HTTP) format.

16. The method of claim 13, wherein the originating server is a mail server.

17. The method of claim 16, wherein the sending comprises sending the e-mail message in a Post Office Protocol Ver. 3 (POP3) format.

18. A method, implemented on an apparatus, of transporting an electronic mail (e-mail) message which designates an addressee by a multilingual e-mail address (MLEA), the MLEA being associated with an encoding type, the method comprising:
receiving an ASCII compatible encoding e-mail address (ACEEA) corresponding to the MLEA;
receiving data representing the encoding type of the MLEA;
converting the ACEEA to the MLEA in accordance with the encoding type of the MLEA; and
sending the e-mail message with the corresponding ACEEA.

19. The method of claim 18, wherein the e-mail message is transported through an originating server, and a destination server in this order, and the converting is performed in the destination server.

20. The method of claim 19, wherein the e-mail message includes the data representing the encoding type in a header portion thereof.

21. The method of claim 20, further comprising:
storing the e-mail message having the ACEEA in a storage device;
receiving from an addressee of the e-mail message a request for retrieving the e-mail message;
retrieving the e-mail message from the storage device; and
forwarding the converted MLEA to the addressee.

22. The method of claim 19, wherein the destination server is a web server.

23. The method of claim 22, wherein the sending comprises sending the e-mail message in a Hyper Text Transport Protocol (HTTP) format.

24. The method of claim 19, wherein the destination server is a mail server.

25. The method of claim 24, wherein the sending comprises sending the e-mail message in a Post Office Protocol Ver. 3 (POP3) format.

26. A method, implemented on an apparatus, of transporting an electronic mail (e-mail) message which designates an addressee by a multilingual e-mail address (MLEA), the MLEA being associated with an encoding type, the method comprising:
receiving the MLEA;
transferring the MLEA through a directory server for conversion of the MLEA;
converting the MLEA to a corresponding ASCII compatible encoding e-mail address (ACEEA) in accordance with the encoding type of the MLEA in a directory server; and
sending the e-mail message with the corresponding ACEEA.

27. The method of claim 26, further comprising storing the MLEA in a header portion of the e-mail message.

28. The method of claim 27, further comprising detecting the encoding type of the MLEA.

29. The method of claim 28, wherein the directory server runs Lightweight Directory Access Protocol.

30. A computer program product comprising a machine readable medium on which is provided program instructions for performing a method of transporting an electronic mail (e-mail) message which designates an addressee by a multilingual e-mail address (MLEA), the MLEA being associated with an encoding type, the method comprising:
receiving the MLEA;
detecting the encoding type of the MLEA by at least one of (i) identifying the encoding type in a message header for the e-mail message and (ii) matching the a portion of the multilingual e-mail address to the encoding type of the MLEA;
converting the MLEA to a corresponding ASCII compatible encoding e-mail address (ACEEA) in accordance with the encoding type of the MLEA; and
sending the e-mail message with the corresponding ACEEA.

31. The computer program product of claim 30, further comprising storing the MLEA in a header portion of the e-mail message.

32. The computer program product of claim 31, wherein the receiving comprises receiving the MLEA from an e-mail software program.

33. The computer program product of claim 31, wherein the receiving comprises receiving the MLEA from a software program installed in a server.

34. The computer program product of claim 33, wherein the server runs Lightweight Directory Access Protocol.

35. The computer program product of claim 33, wherein the server is an e-mail server.

36. The computer program product of claim 33, wherein the server is a web server.

37. A computer program product comprising a machine readable medium on which is provided program instructions for performing a method of transporting an electronic mail (e-mail) message which designates an addressee by a multilingual e-mail address (MLEA), the MLEA being associated with an encoding type, the method comprising:
receiving the MLEA;
transferring the MLEA through a directory server for conversion of the MLEA;
converting the MLEA to a corresponding ASCII compatible encoding e-mail address (ACEEA) in accordance with the encoding type of the MLEA in the directory server; and
sending the e-mail message with the corresponding ACEEA.

38. The computer program product of claim 37, wherein the method further comprising storing the MLEA in a header portion of the e-mail message.

39. The computer program product of claim 38, wherein the method further comprising detecting the encoding type of the MLEA.

40. The computer program product of claim 39, wherein the directory server runs Lightweight Directory Access Protocol.

41. An apparatus comprising:
one or more processors;
a memory coupled to at least one of the one or more processors; and
an interface capable of receiving an electronic mail (e-mail) message which designates an addressee by a multilingual e-mail address (MLEA), the MLEA being associated with an encoding type, wherein at least one of the one or more processors is designed or configured to
receive the MLEA;
detect the encoding type of the MLEA by at least one of (i) identifying the encoding type in a message header for the e-mail message and (ii) matching the a portion of the multilingual e-mail address to the encoding type of the MLEA;
convert the MLEA to a corresponding ASCII compatible encoding e-mail address (ACEEA) in accordance with the encoding type of the MLEA; and
send the e-mail message with the corresponding ACEEA.

42. The apparatus of claim 41, wherein at least one of the one or more processors is designed or configured to detect the encoding type of the MLEA.

43. The apparatus of claim 42, further comprising an SMTP client which sends the e-mail message with the corresponding ACEEA.

44. The apparatus of claim 41, wherein at least one of the one or more processors is designed or configured to detect the encoding type of the MLEA.

45. The apparatus of claim 44, wherein at least one of the one or more processors is designed or configured to
receive the MLEA in a Lightweight Directory Access Protocol (LDAP) format; and
send the ACEEA in the LDAP format.

46. The apparatus of claim 41, wherein at least one of the one or more processors is designed or configured to detect the encoding type of the MLEA.

47. The apparatus of claim 46, further comprising an HTTP port which receives the e-mail message with the MLEA; and an SMTP client which sends the e-mail message with the corresponding ACEEA.

48. The apparatus of claim 46, further comprising an SMTP port which receives the e-mail message with the MLEA; and an SMTP client which sends the e-mail message with the corresponding ACEEA.

49. The apparatus of claim 41, wherein at least one of the one or more processors is designed or configured to receive data representing the encoding type of the MLEA.

50. The apparatus of claim 49, further comprising:
a storage device which stores the e-mail message with the corresponding ACEEA;
an SMTP port which receives the e-mail message with the corresponding ACEEA; and
an HTTP port which sends the e-mail message with the MLEA.

51. The apparatus of claim 49, further comprising:
a storage device which stores the e-mail message with the corresponding ACEEA;
an SMTP port which receives the e-mail message with the corresponding ACEEA; and
a POP port which sends the e-mail message with the MLEA.
